(19) United States
(12) Patent Application Publication
(10) Pub. No.: US 2009/0201577 A1
(43) Pub. Date: Aug. 13, 2009

(54) LIGHT SOURCE

(75) Inventors: Mark LaPlante, Vergennes, VT (US); Edward Kiegle, Chester, VT (US); Jay Reichman, Walpole, NH (US); Julie Martin, Monkton, VT (US)

Correspondence Address: OCCHIUTI ROHLICEK & TSAO, LLP, 10 FAWCETT STREET, CAMBRIDGE, MA, 02138, US

(73) Assignee: Chroma Technology Corporation, Rockingham, VT (US)

(21) Appl. No.: 12/205,383

(22) Filed: Sep. 5, 2008

Related U.S. Application Data
(60) Provisional application No. 60/970,045, filed on Sep. 5, 2007.
(60) Provisional application No. 61/039,148, filed on Mar. 25, 2008.
(60) Provisional application No. 61/083,361, filed on Jul. 24, 2008.

(51) Int. Cl. G02B 13/14; H01J 63/04

(52) U.S. Cl. 359/355; 313/501

(57) ABSTRACT

An apparatus for providing light to molecules of a specimen in a fluorescence microscope includes a light emitting diode and an optical element including a phosphor. The molecules have a peak excitation wavelength. The LED emits light at a first wavelength; the phosphor is capable of receiving the light at the first wavelength and emitting light at a preselected second wavelength different than the first wavelength. The second wavelength is substantially similar to the peak excitation wavelength of the molecules.

### CROSS-REFERENCE TO RELATED APPLICATIONS

This application claims priority to U.S. provisional application Ser. No. 60/970,045, filed Sep. 5, 2007, and entitled “LED Microscopy Light Source;” U.S. provisional application Ser. No. 61/039,148, filed Mar. 25, 2008, and entitled “Light Source;” and U.S. provisional application Ser. No. 61/083,361, filed Jul. 24, 2008, and entitled “Light Source,” all of which are herein incorporated by reference.

### FIELD OF THE INVENTION

This invention relates to light sources.

### BACKGROUND

Fluorescence microscopy is a light microscopy technique for studying the structure or properties of a sample by imaging fluorescent or phosphorescent emission from target species, such as organic molecules or inorganic compounds, located on or in a sample. For instance, a sample may be labeled with fluorophores, molecules that are excited by absorbing light around a specific wavelength (the peak excitation wavelength) and, in response, fluoresce, or emit light at a wavelength longer than the peak excitation wavelength. A fluorescence image of the labeled sample can be obtained by detecting the emitted fluorescence.

The light used to excite the sample in a fluorescence microscope generally has a narrow range of wavelengths to avoid spectral overlap with the emission wavelength, a situation that would generate noise or otherwise interfere with detection of fluorescent emission from the sample. Typical light sources are xenon and mercury arc-discharge lamps or incandescent halogen lamps. Xenon and incandescent halogen lamps produce white light; mercury lamps produce light having several broad emission bands at various wavelengths. The use of excitation filters is required with these light sources in order to restrict the wavelengths of light reaching the sample.

More recently, light-emitting diodes (LEDs) have been used as light sources in fluorescence microscopy. LEDs are semiconductor devices that emit light in a narrow wavelength band. The wavelength of light emitted from an LED depends on the semiconductor material of the LED. LEDs are desirable for use in fluorescence microscopes because the narrow wavelength band of emission obviates the need for excitation filters, and because their emission tends to be more stable than emission from arc-discharge or incandescent lamps. LEDs are also preferred for use in fluorescence microscopy because their output can be electronically controlled, unlike filtered wide band light sources such as arc-discharge or incandescent lamps.

### SUMMARY

This invention relates to an apparatus for providing light to molecules of a specimen in a fluorescence microscope, the molecules having a peak excitation wavelength.

In a general aspect of the invention, the apparatus includes an LED and an optical element including a phosphor. The LED emits light at a first wavelength. The phosphor is capable of receiving the light at the first wavelength and emitting light at a preselected second wavelength different than the first wavelength. The second wavelength is substantially similar to the peak excitation wavelength of the molecules.

Embodiments may include one or more of the following. The optical element is a dichroic short-pass thin film filter applied to a transparent substrate. The dichroic short-pass thin film filter is configured to transmit the first wavelength and reflect the second wavelength. The phosphor is applied as a thin film on an opposite side of the transparent substrate from the dichroic short-pass thin film filter. The transparent substrate is oriented such that the dichroic short-pass thin film filter is on the side facing the LED. The dichroic short-pass thin film filter is configured to provide index matching between air and the transparent substrate. The thickness of the thin film of the phosphor is sufficient to allow some of the light emitted by the LED to be transmitted through the thickness of the thin film. The optical element includes a lens positioned to receive the light emitted by the phosphor. The optical element includes a dichroic long-pass thin film filter positioned to receive the light emitted by the phosphor. The dichroic long-pass thin film filter is capable of reflecting the first wavelength and transmitting the second wavelength. The apparatus includes a liquid cooling system for cooling the optical element. The first wavelength is 463 nm and the second wavelength is 550 nm or 537 nm. The light emitted by the LED has a power of at least 6 Watts, e.g., between 6 and 8 Watts. The phosphors are configured to convert at least 80% of the light emitted by the LED, e.g., between 80% and 90% of the light emitted by the LED.

In another aspect, an apparatus for providing light to molecules of a specimen in a fluorescence microscope includes a plurality of LEDs and a plurality of optical elements each including a phosphor, each optical element receiving the light emitted from one LED. Each LED emitting light at a different LED emission wavelength. Each phosphor is capable of receiving the light at the LED emission wavelength of the one LED and emitting light at a different preselected phosphor emission wavelength. At least one of the phosphor emission wavelengths is substantially similar to at least one of the peak excitation wavelengths of the molecules

Embodiments may include one or more of the following. The apparatus includes a liquid cooling system for cooling the plurality of optical elements. The apparatus includes a means for electronically switching each LED on and off. The apparatus includes a plurality of dichroic mirrors, each dichroic mirror associated with one optical element. The plurality of dichroic mirrors is configured to form the light emitted from each phosphor into a single beam.

In another aspect, an apparatus for providing light to molecules of a specimen in a fluorescence microscope includes a plurality of LEDs and an optical element including a phosphor. The LEDs each emit light at a first wavelength. The phosphor is capable of receiving the light at the first wavelength and emitting light at a preselected second wavelength different than the first wavelength, the second wavelength substantially similar to the peak excitation wavelength of the molecules.

In a further aspect, an apparatus for providing light to molecules of a specimen in a fluorescence microscope, the molecules having a peak excitation wavelength includes an LED, a first optical element including a first phosphor, and a second optical element including a second phosphor. The LED emits light at a first wavelength. The first phosphor is capable of receiving the light at the first wavelength and capable of emitting light at a preselected second wavelength different than the first wavelength. The second phosphor capable of receiving the light at the second wavelength and emitting light at a preselected third wavelength different than the first and second wavelengths. The third wavelength is substantially similar to the peak excitation wavelength of the molecules.

In another aspect, an apparatus for providing light to molecules of a specimen in a fluorescence microscope includes an LED and an optical element including a liquid containing quantum dots. The LED emits light at a first wavelength. The quantum dots are capable of receiving the light at the first wavelength and capable of emitting light at a preselected second wavelength different than the first wavelength. The second wavelength is substantially similar to the peak excitation wavelength of the molecules. In an embodiment, the optical element further includes a phosphor capable of receiving the light at the first wavelength and capable of emitting light at the second wavelength.

In another aspect, a system includes a first LED or laser diode, a first dichroic mirror, a second LED or laser diode, and a second dichroic mirror. The first LED or laser diode is capable of emitting an output light having a first wavelength correlated with an excitation wavelength of a first fluorescent or phosphorescent molecule. The first dichroic mirror is disposed along an optical path from the first light emitting diode or laser diode to a microscope. The second LED or laser diode is capable of emitting an output light having a second wavelength correlated with an excitation wavelength of a second fluorescent or phosphorescent molecule. The first wavelength and the second wavelength are different. The second dichroic mirror is disposed along an optical path from the second light emitting diode or laser diode to the microscope.

Embodiments include one or more of the following. The system includes a first collimating device and a second collimating device. The first collimating device is disposed along an optical path from the first LED or laser diode to the first dichroic mirror. The second collimating device is disposed along an optical path from the second LED or laser diode to the second dichroic mirror. The system includes a third LED or laser diode, a third dichroic mirror, a fourth LED or laser diode, and a fourth dichroic mirror. The third LED or laser diode is capable of emitting an output light having a third wavelength correlated with an excitation wavelength of a third fluorescent or phosphorescent molecule, the third wavelength different from the first wavelength and the second wavelength. The third dichroic mirror is disposed along an optical path from the third LED or laser diode to the microscope. The fourth LED or laser diode is diode capable of emitting an output light having a fourth wavelength correlated with an excitation wavelength of a fourth fluorescent or phosphorescent molecule, the fourth wavelength being different from the first wavelength, the second wavelength, and the third wavelength. The fourth dichroic mirror is disposed along an optical path from the fourth LED or laser diode to the microscope.

The first LED or laser diode includes an ultraviolet LED and the first wavelength is from about 200 nm to about 400 nm. The second LED or laser diode includes a visible spectrum LED and the second wavelength is from about 400 nm to about 700 nm. The second LED or laser diode includes a blue LED and the second wavelength is from about 440 nm to about 480 nm. The third LED or laser diode includes a green LED and the third wavelength is from about 500 nm to about 570 nm. The fourth LED or laser diode includes a red/orange LED and the fourth wavelength is from about 570 nm to about 700 nm. The first wavelength is from about 360 nm to about 370 nm. The second LED or laser diode includes a blue LED and the second wavelength is from about 465 nm to about 475 nm. The third LED or laser diode includes a green LED and the third wavelength is from about 520 nm to about 530 nm. The fourth LED or laser diode includes a red/orange LED and the fourth wavelength is from about 585 nm to about 595 nm.

The first fluorescent or phosphorescent molecule includes a fluorophore selected from the group consisting of DAPI and Hoechst. The second fluorescent or phosphorescent molecule includes a fluorophore selected from the group consisting of EGFP and FITC. The third fluorescent or phosphorescent molecule comprises a fluorophore selected from the group consisting of TRITC and Cy3. The fourth fluorescent or phosphorescent molecule comprises a fluorophore selected from the group consisting of Texas Red and mCherry.

The system includes a third collimating device disposed along an optical path from the third light emitting diode or laser diode to the third dichroic mirror and a fourth collimating device disposed along an optical path from the fourth light emitting diode or laser diode to the fourth dichroic mirror. The system includes a cooling system. The cooling system includes a heat sink and a fan. The system includes a control box operatively connected to the first LED or laser diode and the second LED or laser diode. The control box is configured to control the power applied to the first LED or laser diode and the second LED or laser diode. The control box includes a power switch and an LED enable switch.

In another aspect, a system includes a first LED or laser diode, a first dichroic mirror, a first collimating device, a second LED or laser diode, a second dichroic mirror, a second collimating device, a third LED or laser diode, a third dichroic mirror, a third collimating device, a fourth LED or laser diode, a fourth dichroic mirror, and a fourth collimating device. The first LED or laser diode is capable of emitting an output light having a first wavelength correlated with an excitation wavelength of a first fluorescent or phosphorescent molecule. The first wavelength is from about 200 nm to about 400 nm. The first dichroic mirror is disposed along an optical path from the first LED or laser diode to a microscope. The first collimating device is disposed along an optical path from the first LED or laser diode to the first dichroic mirror. The second LED or laser diode is capable of emitting an output light having a second wavelength correlated with an excitation wavelength of a second fluorescent or phosphorescent molecule. The second wavelength is from about 440 nm to about 480 nm. The second dichroic mirror is disposed along an optical path from the second LED or laser diode to the microscope. The second collimating device is disposed along an optical path from the second LED or laser diode to the second dichroic mirror. The third LED or laser diode is capable of emitting an output light having a third wavelength correlated with an excitation wavelength of a third fluorescent or phosphorescent molecule. The third wavelength is from about 500 nm to about 570 nm. The third dichroic mirror is disposed along an optical path from the third LED or laser diode to the microscope. The third collimating device is disposed along an optical path from the third LED or laser diode to the third dichroic mirror. The fourth LED or laser diode is capable of emitting an output light having a fourth wavelength correlated with an excitation wavelength of a fourth fluorescent or phosphorescent molecule. The fourth wavelength is from about 570 nm to about 700 nm. The fourth dichroic mirror is disposed along an optical path from the fourth LED or laser diode to the microscope. The fourth collimating device is disposed along an optical path from the fourth LED or laser diode to the fourth dichroic mirror.

In one embodiment, the first wavelength is from about 360 nm to about 370 nm. The second LED or laser diode includes a blue LED and the second wavelength is from about 465 nm to about 475 nm. The third LED or laser diode includes a green LED and the third wavelength is from about 520 nm to about 530 nm. The fourth LED or laser diode includes a red/orange LED and the fourth wavelength is from about 585 nm to about 595 nm.

In a further aspect, a system includes a first LED, a first laser diode, one or more optical components, and a control system. The first LED is capable of emitting light having a first wavelength correlated with an excitation wavelength of a first fluorescent or phosphorescent molecule. The first laser diode is capable of emitting light having a second wavelength correlated with an excitation wavelength of a second fluorescent or phosphorescent molecule, the second wavelength being different than the first wavelength. The one or more optical components are configured to combine light emitted from the first LED and light emitted from the first laser diode to form an output light to a microscope. The control system is configured to control an intensity of light of the first wavelength and an intensity of light of the second wavelength in the output light based on a desired characteristic of the output light and a respective output power emitted by the first LED and the first laser diode.

The use of an optical element including a phosphor having the above characteristics has advantages in a number of applications including fluorescence microscopy. In particular, scientists and laboratory technicians can select a phosphor that is capable of receiving light at a first wavelength and emitting light at a preselected second wavelength different than the first wavelength and substantially similar to the peak excitation wavelength of molecules of a specimen. Because the phosphor has an emission wavelength similar to the peak excitation wavelength of molecules of a specimen to be examined, the LED used to excite the phosphor is not required to emit light at the preselected second wavelength similar to the peak excitation wavelength of molecules of the specimen. Commercially available LEDs that provide sufficient power for exciting the molecules of a specimen may not be available at desired wavelengths. In those circumstances, LEDs that generate sufficient power at those wavelengths generally are custom developed at high cost or lower power LEDs are combined in an array to generate sufficient power. Among other advantages, the use of an optical element including a phosphor allows for the use of less expensive, commercially available LEDs paired with an appropriate phosphor necessary for exciting the molecules of the specimen under test. Thus, scientists and technicians are provided with access to wavelengths necessary to efficiently excite certain fluorophores whose peak excitation wavelength is not substantially similar to the emission wavelength of any existing LED.

### BRIEF DESCRIPTION OF DRAWINGS

FIG. 1 is a schematic diagram of a fluorescence microscopy system.

FIG. 2 is a schematic diagram of the structure of one embodiment of an optical filter having a phosphor.

FIG. 3 is a graph of the absorption and emission spectra for a representative LED, phosphor, and fluorophore.

FIG. 4 is a schematic diagram of the structure of another embodiment of an optical filter having a phosphor.

FIG. 5 is a schematic diagram of a fluorescence microscopy system configured for multiple wavelength excitation.

FIG. 6 is a schematic diagram of a control box.

FIG. 7 is a schematic diagram of an optical filter having a phosphor powered by multiple LEDs.

FIG. 8 is a schematic diagram of a liquid cooling system for an optical filter having a phosphor.

FIG. 9 is a schematic diagram of a quantum dot emission element.

FIG. 10 is a schematic diagram of another embodiment of a fluorescence microscope.

FIG. 11 is a schematic diagram of a light engine.

### DETAILED DESCRIPTION

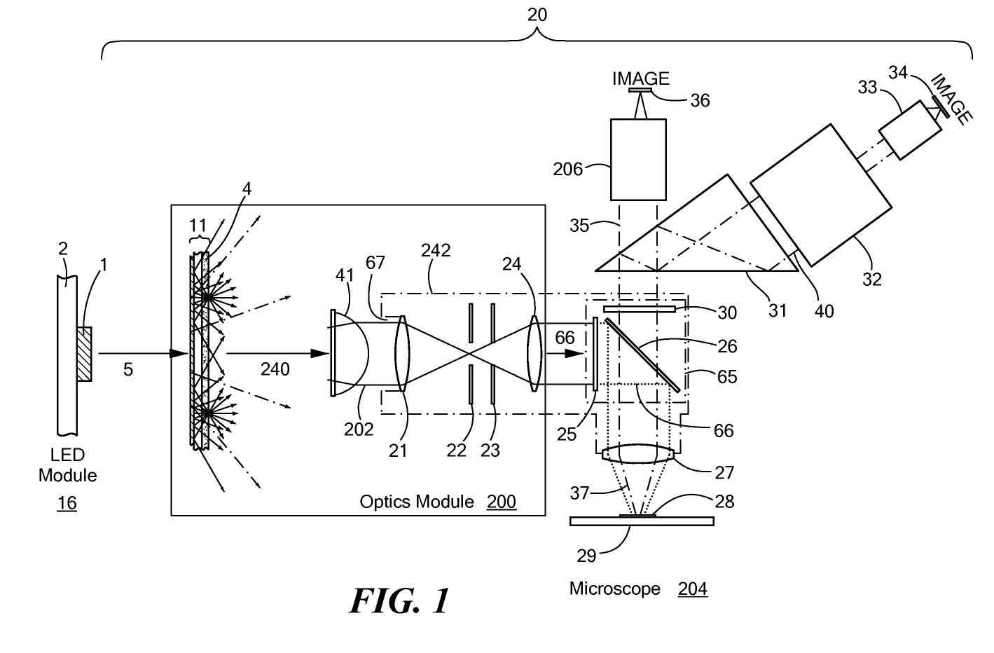

Referring to FIG. 1, a fluorescence microscopy system 20 includes an LED module 16, an optics module 200, and an epi-fluorescence microscope 204. Microscope 204 includes a stage 29 for supporting a sample 28 containing fluorophores having a peak excitation wavelength and an emission wavelength, which is longer than the excitation wavelength.

LED module 16 includes a high-power LED 1 which is connected electrically, thermally, and mechanically to a thermally conductive substrate 2 or a circuit board connected to a cooling system. Electrical energy is provided to LED 1, which emits an LED output light 5 in a narrow wavelength range, for example at 463 nm, with a full width at half maximum (FWHM) of approximately ±12 nm. The LED can be obtained from a variety of commercial sources. For example, a blue LED with a surface area of 120 mm², part number 112601, is available from Luminus Devices, 1100 Technology Park Drive, Billerica, Mass. 01821. LED 1 preferably emits between 6-8 watts of power.

The output light 5 from LED module 16 is received in the optics module 200 by an optical filter 11, which includes a phosphor layer 4, characterized by having a output wavelength that overlaps with the peak excitation wavelength of the fluorophores in sample 28. In one example, upon receiving LED output light 5 at a wavelength of 463 nm, phosphor layer 4 emits phosphor output light 240 at a wavelength of 550 nm.

Output light 240 is received by a short focal length lens 41 which produces a collimated beam (represented by line 202). Lens 41 can be an aspheric condenser lens or a system of lenses. Collimated beam 202 enters a housing 242 enclosing additional optical elements of the optics module 200 via an epi-illumination port 67 and is focused by a condenser lens 21 to a minimum size in the plane of an aperture stop iris 22. The aperture stop 22 restricts the size and shape of beam 202 in order to enhance the resolution and contrast of an image ultimately produced by an objective lens 27 in microscope 204. After passing aperture stop 22, beam 202 diverges and passes a field stop iris 23 which adjusts the intensity of beam 202, and then is re-collimated by a relay lens 24 into an excitation beam (represented by line 66), which is received by microscope 204 for illuminating the sample.

Microscope 204 includes other optical elements for directing light to appropriate portions of the microscope. In one embodiment, microscope 204 includes an optional long-pass filter 25, which receives excitation beam 66. A dichroic long-pass mirror 26 reflects excitation beam 66 into the objective lens 27, which focuses the excitation beam onto the sample 28. The fluorophores in sample 28 emit a fluorescent emission light 37, which is directed by the objective lens 27 to the dichroic long-pass mirror 26. The dichroic long-pass mirror 26 allows fluorescent emission light 37 to pass and reflects any remaining excitation light. A band pass filter 30 transmits only components of fluorescent emission light 37 having a wavelength corresponding to the emission wavelength of the fluorophores in sample 28. A beam splitter 31 then splits the transmitted emission light into two beams represented by lines 35 and 40. A first relay lens system 206 directs beam 35 onto a face 36 of a detector, sensor, or spectrophotometer, preferably a CCD camera or equivalent, for imaging or recording. A second relay lens system 32 directs beam 40 into an eyepiece 33 to be viewed by an operator.

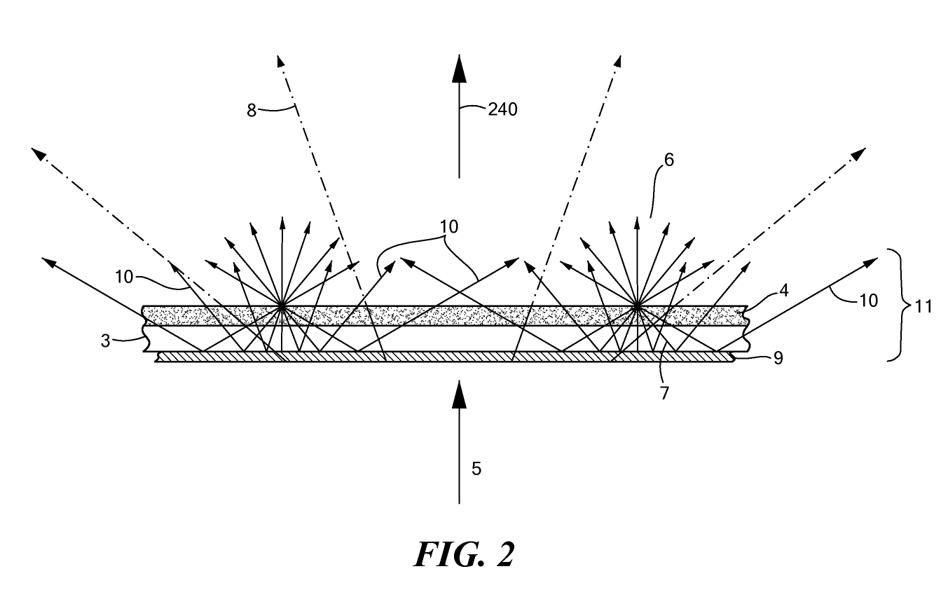

Referring to FIG. 2, in one embodiment, optical filter 11 includes a dichroic short-pass thin film filter 9 supported on a surface of a glass slide 3 nearest LED module 16. Optical filter 11 also includes a layer of phosphor 4 on the opposite surface. Phosphor 4 has an excitation (absorption) wavelength within the range of the wavelength of the LED output light 5. Upon absorbing output light 5, the phosphor 4 emits light 6, 7 at an emission wavelength longer than the wavelength of the LED output light 5. The phosphors have a conversion efficiency of preferably between 80% and 90%. The phosphor may be a compound containing sulfoselenide, as described in U.S. Pat. No. 7,109,648 and hereby incorporated by reference, although any other phosphor compound, molecule, chemical, or material, such as quantum dots, can be used. For example, the preferred phosphor to generate phosphor emission light with a wavelength of 550 nm is Product No. BUVY02, available from PhosphorTech Corporation, 351 Thornton Road, Lithia Springs, Ga. 30122. Alternatively, if light centered about 537 nm is desired, phosphor BUVG01, also available from PhosphorTech Corporation, could be used. To obtain a desired emission wavelength, one type of phosphor is easily interchangeable with another type of phosphor by removing optical filter 11 from the optics module 200 and inserting a different optical filter including a different phosphor.

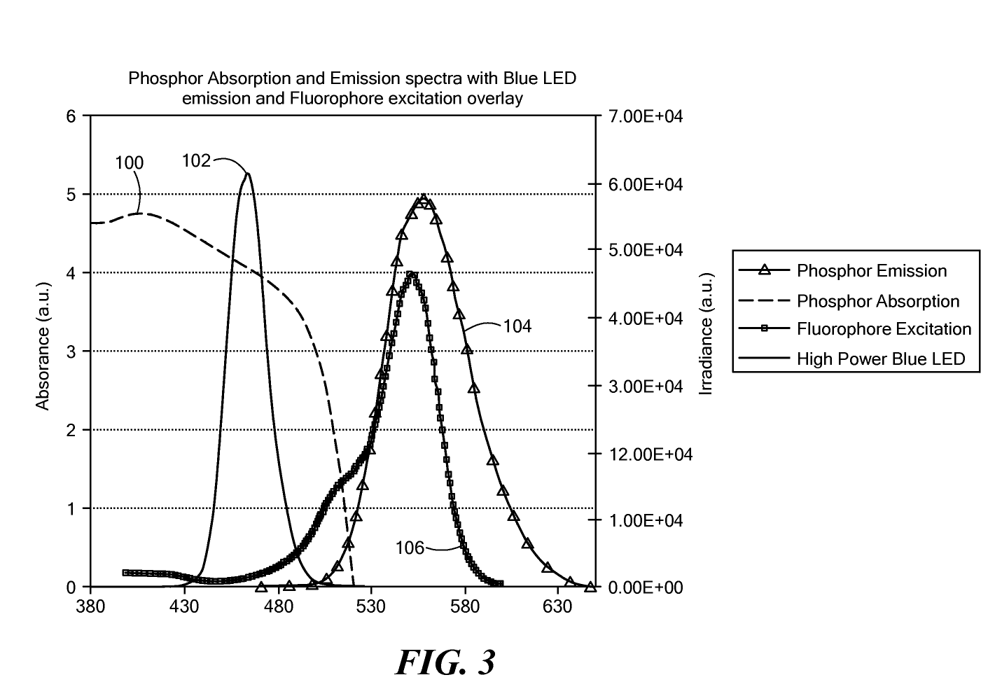

Referring to FIG. 3, the phosphor Product No. BUVY02 has an absorption spectrum 100 that overlaps with an emission spectrum 102 of an LED 1, and has an emission spectrum 104 that overlaps with an excitation spectrum 106 of a fluorophore in sample 28.

Referring again to FIG. 2, the phosphor is mixed with a transparent binder and screened onto optical filter 11 to form a layer of controlled thickness. The thickness must be adjusted so that at full power of the LED, phosphor throughout the entire thickness of the layer can be excited by the LED output light 5. Properly adjusting the thickness of the layer will minimize re-absorption of the light 6, 7 emitted by the phosphor while enabling maximal excitation of the phosphor by the LED output light 5. A portion 8 of the LED output light 5 may pass through the layer of phosphor 4 without being absorbed.

The phosphor emits light in a Lambertian pattern, including both forward-propagating light 6 (which propagates in a desired direction) and backward-propagating light 7. Dichroic short-pass thin film filter 9 transmits light having a wavelength shorter than a cutoff wavelength and reflects light with a longer wavelength. The cutoff wavelength of filter 9 is chosen such that filter 9 reflects backward-propagating light 7 in the desired direction toward microscope 204. Since the wavelength of the LED output light 5 is shorter than the cutoff wavelength of filter 9, LED output light 5 is received by phosphor 4. For example, for an LED with an output wavelength of 463 nm and a phosphor with an emission wavelength of 550 nm, filter 9 may have a cutoff wavelength of around 510 nm. The light emitted by phosphor 4 contains forward-propagating light 6 and reflected light 10 at the emission wavelength of the phosphor as well as light 8 at the wavelength of the LED output light. Additionally, filter 9 may provide index matching to allow penetration of the glass slide 3 by more of the LED output light 5.

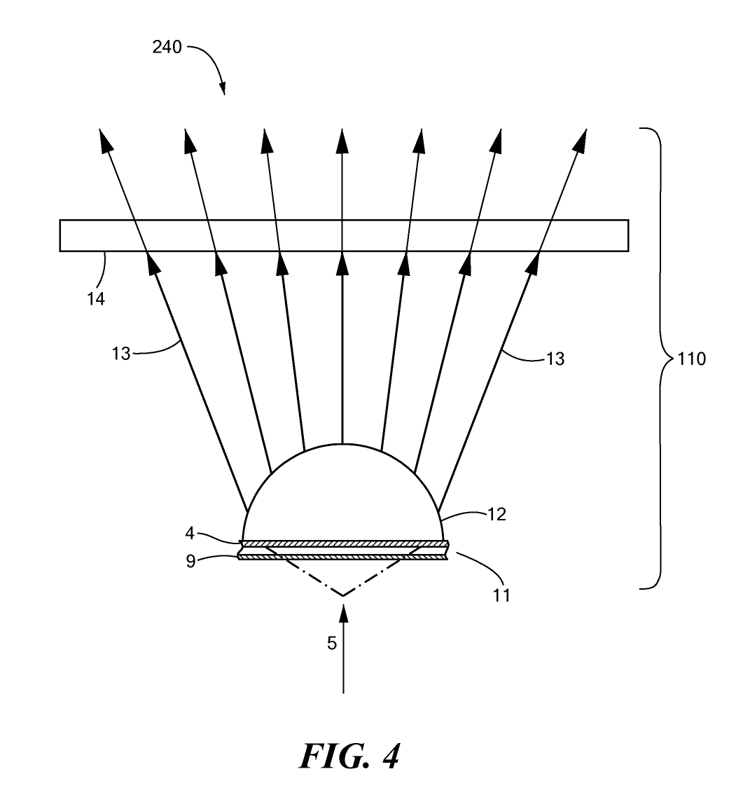

Referring to FIG. 4, in another embodiment, an optical filter 110 additionally includes a half-ball lens 12, which captures the divergent light 6, 8, 10 exiting the layer of phosphor 4 and forms it into a less divergent beam (represented by the lines 13). Lens 12 allows beam 13 to maintain a higher intensity as it propagates away from optical filter 11 and enables the beam to be more efficiently collimated with lower loss. A dichroic thin film long-pass filter 14 may be added in the path of beam 13 to reflect the light 8 at the wavelength of the LED output light, resulting in output light 240 containing primarily light 6, 10 (shown in FIG. 2) at the emission wavelength of the phosphor.

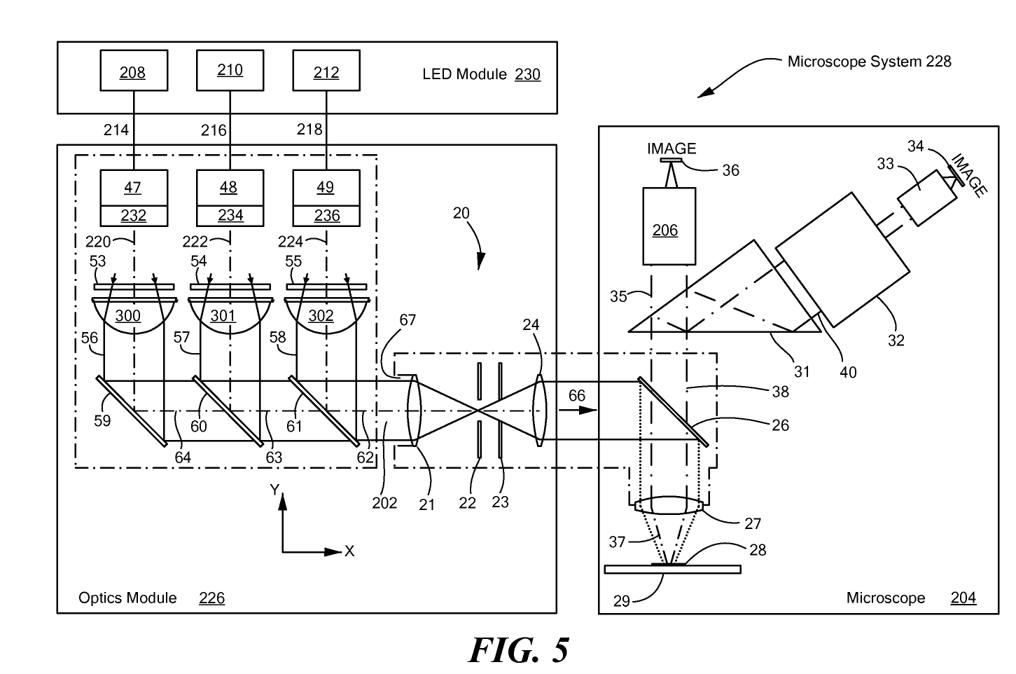

Referring to FIG. 5, in another embodiment, a fluorescence microscopy system 228 configured for multiple wavelength excitation includes an LED module 230, an optics module 226, and an epifluorescence microscope 204. LED module 230 contains a cooling system 231. A peripheral bench top control box 233 (e.g., a hand control) interfaces with LED module 230 to allow a user to control the intensity of the light emitted by LED 1 by modulating power to the LED. A sample 28 containing multiple kinds of fluorophores, each kind having a different peak excitation wavelength, is supported by a stage 29 in microscope 204.

The LED module 230 contains multiple LEDs 208, 210, 212, each emitting an LED output light 214, 216, 218, respectively, each with a different wavelength. Each LED output light 214, 216, 218 is received in the optics module 226 by a corresponding optical filter 47, 48, 49, each containing a layer of phosphor 232, 234, 236, respectively. Each layer of phosphor 232, 234, 236 is capable of absorbing the wavelength of the LED output light 214, 216, 218 that is incident on the corresponding optical element. The phosphors 232, 234, 236 emit phosphor emission light 220, 222, 224 with wavelengths λ220, λ222, λ224, such that λ220>λ222>λ224. Each of these wavelengths may overlap with the peak excitation wavelength of at least one kind of fluorophore in sample 28. Each optical filter 47, 48, 49 further includes a dichroic long-pass filter 53, 54, 55, respectively, which transmits only the phosphor emission light and reflects the LED output light, as described above in conjunction with FIG. 2.

Collimating optics 300, 301, 302 convert the phosphor emission light 220, 222, 224 into collimated beams represented by lines 56, 57, 58. Dichroic optical elements 59, 60, 61 receive each collimated beam 56, 57, 58 and collectively combine the beams into a single beam (represented by line 202) containing wavelengths λ220, λ222, and λ224. Element 59 is a dichroic mirror or reflector that reflects light with a wavelength λ220 along an optical axis 64 towards element 60. Element 60 is a dichroic long-pass filter that transmits λ220 and reflects λ222 along an optical axis 63 towards element 61. Element 61 is a dichroic long-pass filter that transmits λ220 and λ222 and reflects λ224 along an optical axis 62 towards the epi-illumination port 67. That is, elements 59, 60, and 61 reflect the wavelength of the associated LED and transmit the light from upstream LEDs. Optical axis 62 is the optical axis of the epi-illumination port 67. Elements 59, 60, and 61 must be offset in the −Y direction such that the optical axes 62, 63, 64 are aligned with each other. It should be noted that dichroic optical elements 59, 60, 61 can additionally be configured to filter light at the wavelength of the LED output light, thus eliminating the need for the dichroic long-pass filters 53, 54, 55. Beam 202 enters the epi-illumination port 67 and is formed as described above into an excitation beam (represented by line 66) which is received by microscope 204.

Microscope 204 is substantially similar to the microscope shown in FIG. 1, with the exception that the dichroic band pass filters 25 and 30 of FIG. 1 are not present. This configuration allows the multiple wavelengths contained in excitation beam 66 to be passed into the microscope 204, and allows multiple fluorescence emission wavelengths from fluorophores in sample 28 to be imaged in eyepiece 34 or detected on the face 36 of a detector, sensor, or spectrophotometer. An image of the fluorescence from sample 28 is captured for each excitation wavelength λ220, λ222, λ224. Alternatively, a multi-wavelength imaging device, such as a three-chip CCD camera, can be used. Individual wavelengths are analyzed in real time using the three color filters integral to this type of camera. A three color prism can be used instead to split the beam 35 into three separate beams each of a different wavelength, each of which can be diverted to a monochromatic imaging device. Alternatively, a multiband emission filter can be used to restrict the wavelength of fluorescence emission light that reaches the detector.

Although three LEDs 208, 210, 212 and three corresponding optical elements 47, 48, 49 are shown, the number of LEDs and corresponding optical elements is limited only by the wavelengths required by the sample and by the losses inherent to combining multiple beams of emission light into one emission beam. It is also noted that prisms or light guides (reflective or refractive) can be used to perform the beam combination performed by the dichroic optical elements 59, 60, 61.

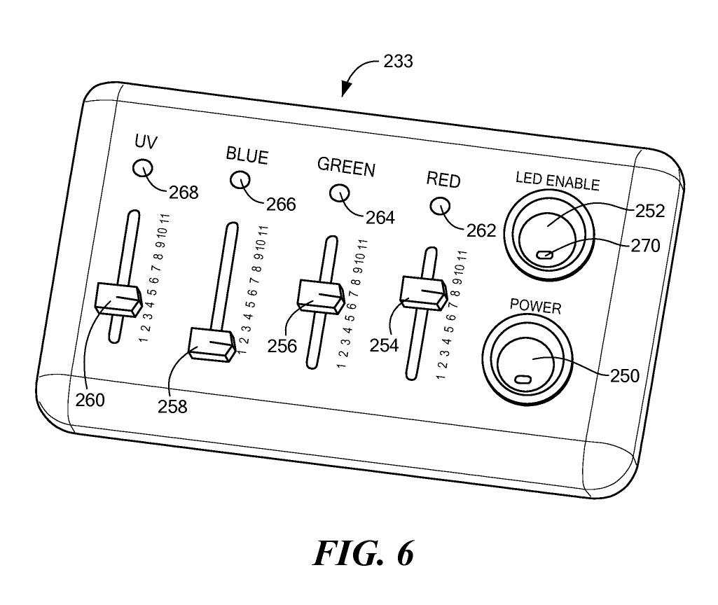

Referring to FIG. 6, control box 233, e.g., a hand control, interfaces with LED module 230 to allow a user to remotely select which LED(s) 208, 210, 212 illuminate (i.e., to control which LEDs are “on”) and to control the intensity of the light emitted by the selected LEDs by modulating the power provided to each LED. Control box 233 has an internal circuit board (not shown), an illuminated main power switch 250, an illuminated LED enable switch 252, and four sliders 254, 256, 258, and 260 with corresponding LED indicator lights 262, 264, 266, and 268. Each slider is associated with one LED in LED module 230; for instance, in this embodiment, sliders 254, 256, and 258 control LEDs 208, 210, and 212, respectively, and slider 260 is not associated with an LED. LED indicator lights 262, 264, 266, and 268 indicate which LEDs are illuminated.

Main power switch 250 applies power to LED module 230; LED enable switch 252 determines when power is applied to the LEDs themselves. When main power switch 252 is turned on, cooling system 231 is powered on and begins cooling the LEDs in LED module 230 to the desired operating temperature. When the operating temperature is reached, a ready indicator light 270 on LED enable switch 252 is illuminated to indicated that LED module 230 is ready for light output. This is the only ‘cool-down’ time (analogous to the ‘warm-up’ time of a lamp-based device) required during a power-on cycle of LED module 230.

When the operating temperature has been reached, LED enable switch 252 can be turned on, powering LEDs 208, 210, and 212 with the power level set by sliders 254, 256, 258, and 260. LED enable switch 252 allows a user to turn off individual LEDs without losing preset intensity levels of the LEDs. For instance, a user may preset the LED intensity levels to desired values and then turn the LEDs on and off quickly to collect an image in microscope 204 without bleaching or heating a live sample. Furthermore, LED enable switch 252 allows adequate cooling of the LEDs to be maintained while the LEDs are cycled on and off. That is, when the LEDs are off (controlled by LED enable switch 252) but the main power to LED module 230 is on (controlled by main power switch 250), cooling system 231 maintains cooling of the LEDs. If main power switch 250 is on, a user can quickly resume an experiment by turning on LED enable switch without incurring the ‘cool-down’ time required when initially turned on LED module 230.

Control box 233 includes circuitry for main power switch 250, LED enable switch 252, and sliders 254, 256, 258, and 260. Additionally, control box 233 includes power to LED indicator lights 262, 264, 266, and 268 and ready indicator light 270. Control box 233 interfaces with LED module 230 via a connectorized cable (not shown). The control box may include rubberized feet on the bottom to prevent the unit from sliding on a surface, such as a bench or desktop, while in use.

In another embodiment, each LED 208, 210, 212 in the LED module 230 can be driven electronically to produce light of its respective wavelength on demand, either simultaneously or in a pre-determined sequence. Electronic switching is performed electronically and is not based on shutters, wheels, or motorized parts that may move and potentially shake the sample. Electronic switching has little or no delay in selecting or switching between wavelengths, and the LEDs can switch on and off rapidly and in a carefully timed manner using simple software control. Each LED can be activated within a few microseconds and synchronized with an imaging device so that discrete images can be captured in sequence. This enables the synchronous real-time study of, for example, biological processes such as live cell mitosis.

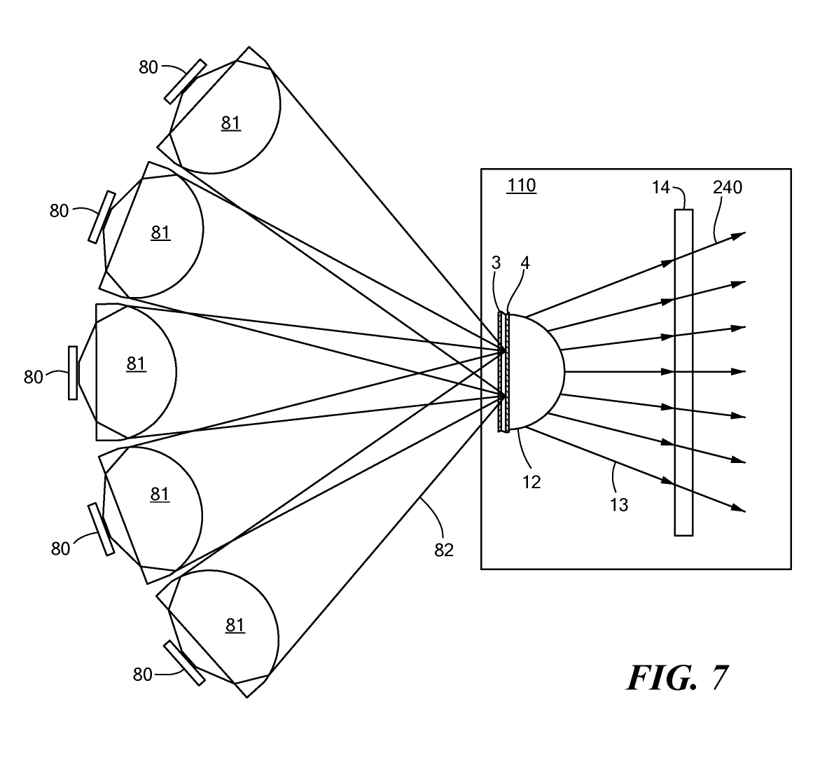

Referring to FIG. 7, multiple LEDs 80 providing light to a single optical filter 110 can be used to increase the intensity of the light emitted by the phosphor 4. Each LED 80 has a lens 81 that focuses LED output light 82 to an area on optical filter 110. The addition of each successive LED 80 adds linearly to the power impinging on the optical filter 110. This configuration may be desirable in order to increase the intensity of the phosphor output light 240 to a level not attainable with the use of only one high-power LED. Alternatively, this may be done to compensate for a desired LED that produces only low power, such as LEDs that emit in the ultraviolet, including the Nichia NCSU033A-E LED which produces a maximum of only about 400 mW of power at 365 nm and can be driven at a maximum of only 700 mA.

In another embodiment, two optical filters 11 can be arranged in series. An LED emits LED output light of a short wavelength that is received by a first optical filter having a layer of a first kind of phosphor. The phosphor absorbs the LED output light and emits light at a first phosphor emission wavelength. This light emitted by the phosphor is received by another optical filter having a layer of a second kind of phosphor, which absorbs light at the first phosphor emission wavelength and emits light at a second phosphor emission wavelength that overlaps with a peak excitation wavelength of a fluorophore in a microscope. This embodiment may be desirable if no LED exists that emits light capable of exciting the second kind of phosphor.

Although the optical filter 11 has been described for use with an epi-fluorescent microscope, it can be used with for any application that would benefit from having monochromatic, high-power light, such as forensics and stage lighting for the performing arts and film and television production. Other microscope devices such as confocal microscopes, inverted microscopes can also utilize the described optical element. It may also be used as a light source for biological assays, such as endoscopic devices, plate readers, slide scanners, fluorescent immunoassays, and quantitative Polymerase Chain Reaction (PCR).

There are many advantages to using the optical element described herein. Emission wavelengths not available from LEDs are made accessible. High emission intensity can be achieved, enabling, for example, sensitive fluorescence measurements or measurements of short duration biological events that require short exposure times. There is no need to filter the emission from a white light source in order to attain an excitation beam of a desired wavelength. Electronic control enables rapid modulation of the intensity and wavelength of an excitation beam.

One consequence of utilizing a high power LED with a power of greater than 8 Watts is that a high drive current is necessary; this high current generates approximately 73 Watts of heat that must be removed from the LED. For a system containing multiple LEDs, such as that shown in FIG. 7, the total heat dissipated can exceed 365 Watts. In some embodiments, the LEDs are mounted on a circuit board which is connected to a cooling system such as a heat sink (e.g., an actively cooled heat sink). The cooling system may also include a fan. Other examples of cooling systems include thermal electric coolers, fans, heat pipes, forced air cooling, and liquid cooling systems. In some embodiments, the cooling system includes a finned heat sink. However, for epi-fluorescence microscope applications, the size of the LED module is restricted to be approximately the size of a housing for a mercury vapor lamp. Heat pipes, heat sinks, and fans are often far too large to fit in this limited space; furthermore, fans create undesirable mechanical vibrations.

Given these constraints, the preferred method for cooling an LED module is to use a forced liquid cooling system. A forced liquid cooling system is relatively compact and allows ample space and capacity to remove heat generated by the LEDs to the surrounding environment. The forced liquid cooling system uses a closed-loop heat exchanger that incorporates a remotely mounted radiator/fan assembly, a coolant pump, a reservoir, and an LED power supply. A liquid plenum cold plate provides a mounting surface for the LEDs as well as adequate capacity to cool the LEDs. For instance, if blue LEDs are used, a safe junction temperature of 120° C. must be maintained, which requires the LED substrate to be kept at a temperature of 60° C. In order to achieve these temperatures, the forced liquid cooling system maintains the liquid at a temperature of 10° C. above ambient temperature, thus providing adequate thermal capacity.

High power operation of LEDs creates significant heat and quenching problems for an optical filter including a phosphor. For example, when operated at its rated current of 18 Amps, a blue LED generates approximately 8.5 Watts of blue light. A significant amount of this light is absorbed as heat by the optical filter 11, exposing both the phosphor 4 and the glass slide 3 on which the phosphor is mounted to extremely high temperatures. Even at more modest LED drive currents, glass slide 3 can reach temperatures well in excess of 250° C., primarily due to poor thermal conductivity of the glass slide. Such a high temperature quenches the emission of the phosphor. At low LED drive currents, the phosphor emission may still be quenched by over 70% for the preferred phosphors described above. Although other phosphors that are better suited to high temperature operation are available, their spectra do not sufficiently match the desired phosphor absorption spectrum and their conversion efficiency is far below that of the preferred phosphors.

One way to eliminate the problem of phosphor quenching is to actively cool the surface of optical filter 11 by directing an air stream onto the face of glass slide 3. However, this method requires fans, which are noisy and consume relatively large amounts of space. Furthermore, air is inefficient in transferring heat over small areas and is prone to carry contamination and dust. A piezo micro-fan, which is a resonant piezo element driven from a power supply, overcomes some disadvantages associated with using an air stream; however, such a device is quite expensive. Given that the LEDs illuminating optical filter 11 are cooled with liquid, it is preferable to also utilize cooling liquid to cool optical filter 11.

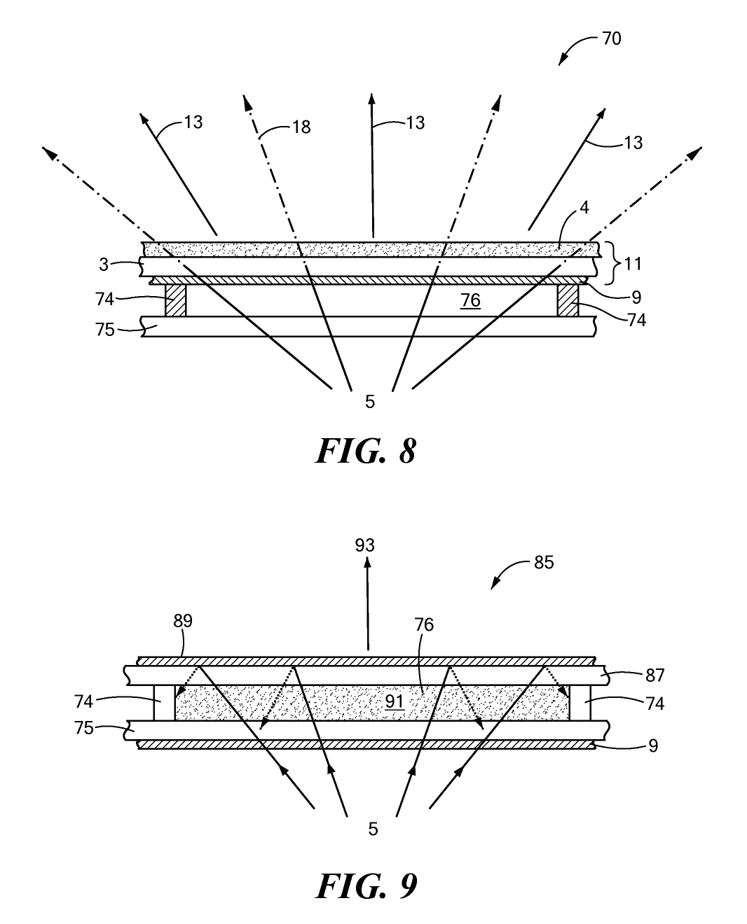

Referring to FIG. 8, a cross-sectional schematic diagram of a liquid cooling system 70 is shown. As described previously, optical filter 11 includes phosphor 4 applied to the top of glass slide 3 and filter 9 applied to the bottom of glass slide 3. Provided filter 9 is sufficiently mechanically robust, a spacer frame assembly 74 can be adhered to filter 9. Otherwise, frame assembly 74 is attached directly to the bottom surface of glass slide 3 and filter 9 is applied to glass slide 3 only in the area contained within frame assembly 74. A second glass slide 75 is attached to the bottom of frame assembly 74. Frame assembly 74 is a square or round ring large enough not to occlude LED output light 5 incident from the LED module 16 (not shown). Any of a number of commercial epoxies or adhesives, such as Dow-Corning Sylgard 184 silicone encapsulant, available from Dow-Corning Corp., may be used to attach frame assembly 74 to optical filter 11 and glass slide 75. When attached and sealed to both optical filter 11 and glass slide 75, frame assembly 74 creates a liquid cooling chamber 76, which is filled with a cooling fluid such as water, distilled water, deionized water, a mixture of water and ethylene glycol (without pigment), a mixture of water and propylene glycol (without pigment), dielectric cooling oil, or any other thermally conductive liquid with suitable transmissive properties. Ports (not shown) in the sides of frame assembly 74 allow the cooling fluid to enter and exit cooling chamber 76 via flexible tubing. If multiple optical filters 11 are used the flexible tubing may connect cooling chamber 76 in series with other cooling chambers associated with other optical filters 11. Alternatively, custom fittings can be used to directly attach and seal cooling chamber 76 to the cooling chambers of adjacent optical filters 11. The cooling chambers associated with the first and last of a series of optical filters 11 are connected with a heat removal plenum that is also used in the forced liquid cooling system of the LED module. With cooling fluid circulating through the cooling chambers 76, the LEDs can be operated at full drive power without appreciable quenching of the phosphor emission.

In other embodiments, quantum dots can be used to provide a desired emission spectrum. Quantum dots have a peak excitation wavelength and an emission wavelength, which is longer than the excitation wavelength. The size of a quantum dot, which can be precisely controlled, determines its emission spectrum. Therefore, emission from quantum dots can be centered in any wavelength range and is not defined primarily by the chemical composition of the material, as is the emission from phosphors. Quantum dots can be suspended in common solvents such as water, alcohol, acetone, or oils. By replacing the cooling liquid in the cooling chamber 76 shown in FIG. 7 with a suspension of quantum dots having an appropriate emission wavelength, enhanced output at the phosphor output wavelength can be achieved while still maintaining proper cooling of the phosphor. In an alternative embodiment, phosphor 4 can be removed from optical filter 11 and emission can be generated entirely by a suspension of quantum dots contained in cooling chamber 76.

Referring to FIG. 9, a quantum dot emission element 85 includes dichroic short-pass thin film filter 9 applied to glass slide 75 closest to LED module 16 (not shown). A second glass slide 87, farther from LED module 16, includes a dichroic long-pass thin film filter 89. Between the two glass slides 75 and 87, frame assembly 74 is positioned as described above to form liquid cooling chamber 76. A quantum dot suspension 91, which has an excitation (absorption) wavelength within the range of the wavelength of LED output light 5, fills and circulates through cooling chamber 76. Quantum dot suspension 91 absorbs LED output light 5 and emits a quantum dot output light 93 at a wavelength longer than the wavelength of the LED output light. Filter 89 transmits quantum dot output light 93 and reflects LED output light 5 back into quantum dot suspension 91. Any light emitted by the quantum dots in the backward direction (i.e., toward the LED) is reflected in the forward direction by filter 9.

An advantage of using quantum dot emission element 85 is that it provides cooling of the quantum dot suspension so that quenching of the quantum dot emission does not occur. It also allows reflection of LED output light 5 back into the quantum dot suspension, where the LED output light can further excite the quantum dots to generate more emission at the desired emission wavelength. Furthermore, it provides a dichroic filter to direct the quantum dot output light 84 in the forward direction. It is also straightforward to switch the quantum dot suspension 91 to another suspension containing quantum dots that emit at a different wavelength by simply draining and purging cooling chamber 76 and refilling the cooling chamber with a suspension of the desired quantum dots. These features can all be achieved in a compact assembly.

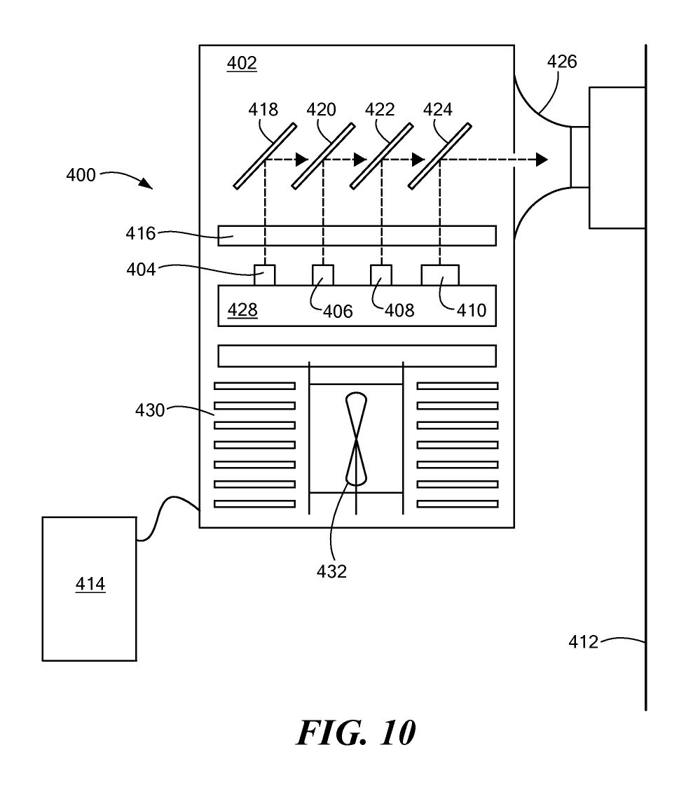

Referring to FIG. 10, in a different embodiment, the wavelength emitted by the LED is the same as the wavelength that illuminates the sample. In a fluorescence microscopy system 400 configured for multi-wavelength illumination, an LED module 402 includes LEDs 404, 406, 408, and 410 that light of various colors to a fluorescence microscope 412. For instance, the LED module may include any or all of an ultraviolet (UV) LED (an LED with a dominant output wavelength between about 200 nm and about 400 nm), a blue LED (an LED with a dominant output wavelength between about 440 nm and about 480 nm), a cyan LED (an LED with a dominant output wavelength between about 480 nm and about 500 nm), a green LED (an LED with a dominant output wavelength between about 500 nm and about 570 nm), a yellow LED (an LED with a dominant output wavelength between about 570 nm to about 600 nm), a red/orange LED (an LED with a dominant output wavelength between about 570 nm and about 700 nm), and/or an infrared/near-infrared LED (an LED with a dominant output wavelength between about 700 nm and about 1400 nm). An exemplary UV LED, which has a peak wavelength of 365 nm, is Model No. NCSU033A high-power UV LED, manufactured by Nichia Corporation, Tokushima, Japan. The fluorescence microscopy system need not include all of the LED colors listed above, and could include, for instance, four colors, five colors, six colors, or more. Multiple LEDs with the same emission wavelength may be included.

Each LED 404, 406, 408, and 410 projects light through collimating optics 416 onto dichroic mirrors 418, 420, 422, and 424, respectively, to combine the wavelengths produced by each LED into a common optical path 426. As described above, the dichroic mirrors are filters that reflect the wavelength of the associated LED and pass the other wavelengths, allowing the light from upstream LEDs to pass through and into microscope 412. For example, dichroic mirror 424 reflects light of the wavelength emitted by LED 410 and transmits light of other wavelengths, allowing light from LEDs 404, 406, 408, and 410 to be transmitted to microscope 412. The LEDs are controlled by a control box 414 such as that shown in FIG. 6.

The LEDs are mounted to a circuit board 428 that is in turn mounted to a cooling system such as a heat sink 430 that includes a fan 432. Other examples of cooling systems are described above.

In one embodiment, the wavelengths of the LEDs are selected based on the excitation wavelength of a particular type of stain, immunofluorescent agent, or genetically encoded fluorescent reporter present on the sample in fluorescence microscope 412. The specificity of LED wavelengths decreases potential photodamage to or photobleaching of the sample by specifically exciting target fluorophores on the sample. Table 1 includes exemplary fluorophores and exemplary LEDs that can be used to excite each fluorophore.

TABLE 1

| | | | | Exemplary | Exemplary |
|---|---|---|---|---|---|
| | | | | range of LED | LED peak |
| | | | | peak (not | (not |
| | | | | dominant) | dominant) |
| Excitation | | Excitation | Emission | wavelength | wavelength |
| Color | Fluorophore | λ (nm) | λ (nm) | (nm) | (nm) |
| UV | DAPI | 359 | 461 | 355-375 | 365 |
| UV | Hoechst | 352 | 461 | 355-375 | 365 |
| Blue | EGFP | 488 | 511 | 460-480 | 470 |
| Blue | FITC | 490 | 525 | 460-480 | 470 |
| Green | TRITC | 550 | 573 | 515-535 | 525 |
| Green | Cy3 | 552 | 568 | 515-535 | 525 |
| Red | Texas Red | 595 | 620 | 580-600 | 590 |
| (Orange) | | | | | |
| Red | mCherry | 587 | 610 | 580-600 | 590 |
| (Orange) | | | | | |

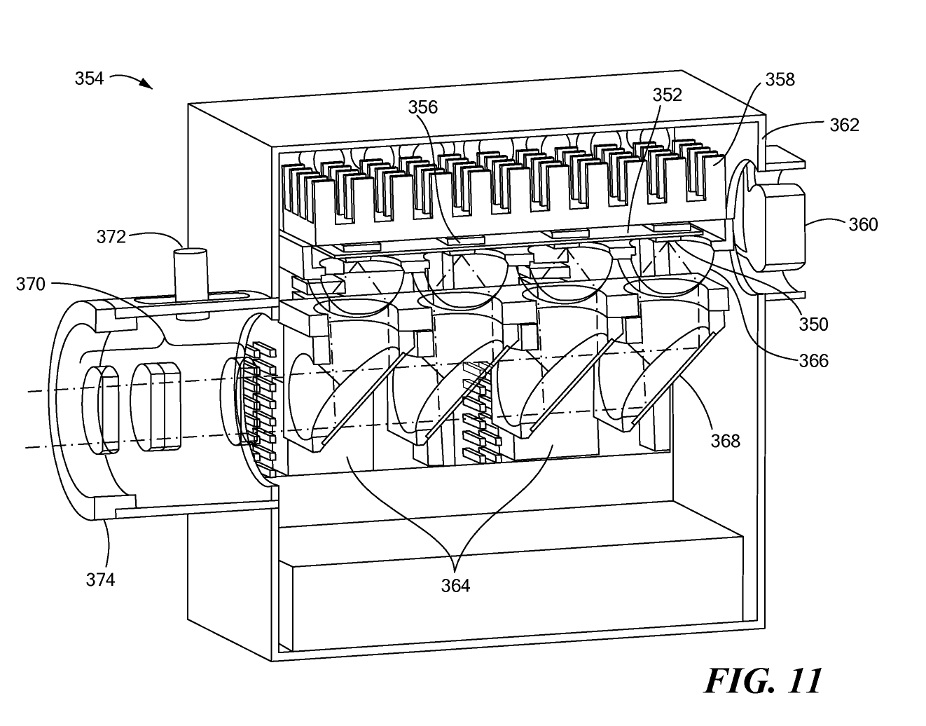

Referring to FIG. 11, in one embodiment, multiple LEDs 350 mounted on a common LED circuit board 352 are contained in a light engine 354. Zero to four LEDs may be simultaneously powered when light engine 354 is in operation. Each LED mechanically interfaces (via heat slugs or a circuit board thermal plane) to a thermal electric cooling (TEC) device 356 mounted on the back side of circuit board 352. Each TEC device 356 mechanically interfaces to a common finned heat sink 358 which is cooled by a fan 360 mounted in an exterior wall 362 of light engine 354. TECs 356 and LEDs 350 are sealed in an environmental compartment within light engine 354 to insulate the cold components and to prevent moisture contamination of the optics and cooling electronics. Because LEDs generally have a long lifetime, running experiments for long periods of time is not problematic in terms of either wear on the LEDs or heat dissipation.

LED circuit board 352 interfaces to a main circuit board (or boards) 364 mounted on a side wall of light engine 354. Main circuit board 364 includes circuitry to interface with the attached control box (shown in FIG. 6), drive LEDs 350 and TECs 356, and control cooling fan 360. A microprocessor (not shown) is utilized to monitor and control temperature and power of LEDs 350 and TECs 356. The microprocessor also provides a USB interface in order to facilitate debugging, tuning, and software upload during development and for performance adjustments.

Light from each LED 350 is collimated using custom collimating lenses 366 mounted below the LEDs. The collimating lenses 366 are integrated into the environmental compartment of light engine 354 and maintained at ambient or slightly higher temperature to prevent condensation on the lenses. Collimating lenses 366 are designed to address the different path lengths, cone angles, wavelengths, and operating temperatures of different LEDs. Each collimated light path is projected onto a dichroic filter 368 mounted at a 45° angle which reflects the specific wavelength associated with the LED and transmits other wavelengths. Light reflected from dichroic filters 368 is projected onto an output lens assembly 370 which focuses the light for input into the microscope. Output lens assembly 370 includes a focus adjustment knob 372 which allows for relative translation of a lens (or lenses) to focus the output light. The ability to focus enables light engine 354 to interface with the illumination optics of various microscopes. Interchangeable microscope adapters 374 allow light engine 354 to be mechanically mounted onto a predetermined set of microscope types.

In some embodiments, one or more of the LEDs is replaced by a laser diode. The light emitted from the laser diode is configured to be optically equivalent to the light emitted by the LED it replaced, such that the difference between light of a particular wavelength emitted by an LED versus light at the same wavelength emitted by a laser diode is not readily apparent to a user and such that neither the LED nor the laser diode illuminate the surface in a significantly different manner. A microscopy system that includes both LEDs and laser diodes also includes an electronic control system designed to account for operational differences between LEDs and laser diodes. For instance, the microscopy system may include electronics configured to ensure that the output power of the laser diode is approximately the same as the output power of the LED it replaced.

Light emitted from a laser diode often generates an undesirable speckle pattern when the light illuminates a rough surface, whereas light emitted from an LED does not produce such a pattern. Speckle patterns arise due to the high coherence of laser diode light. Topographic variations on the rough surface that are larger than the wavelength of the incident coherent laser diode light scatter the incident light. These scattered components interfere to form a stationary pattern. A speckle pattern has a “salt-and-peppery” appearance and seems to scintillate or sparkle when there is relative movement between the rough surface and an observer.

In order to reduce or eliminate the speckle effect, optical components can be added in the path of the laser diode light. One method is to image the laser diode beam onto a translucent or diffuse screen or a holographic optical element, such as a prism. The resulting illuminated area is then imaged through the optical path onto the object being viewed. Alternatively, optical components that change by at least one wavelength of the laser diode light the transverse and/or the longitudinal path length traveled by the laser diode light help to reduce speckle. One option to achieve this is to move the position of the laser diode light so that the resulting speckle pattern moves a greater distance than the apparent separation between nodes of the speckle pattern. If moving the laser diode light through a distance of one wavelength takes less time than the integration time of the detector (e.g., human eye or electronic sensor), the appearance of speckle will be substantially reduced or eliminated. This motion can be accomplished through a variety of means, including passing the laser diode light through a spinning optically clear glass plate having a non-uniform optical thickness (i.e., wedged); by reflecting the laser diode light off of the surface of a piezoelectric mirror that vibrates to average the signal; or by moving the image plane, the focus of the objective lens of the microscope, or the laser diode itself. A suitable piezo mirror tilter is available from PIEZO SYSTEMS, INC., 186 Massachusetts Avenue, Cambridge, Mass. 02139. For example, for viewing by eye, laser diode light passed through a glass wedge with an optical thickness variation that is greater than one period of the laser diode light would be homogenized if the wedge is moved such that the optical path length varies by an amount greater than one period of the laser diode light and at a temporal frequency greater than approximately 50-60 Hz. For electronic viewing (such as with a CCD camera), the time duration would need to be many times shorter than the desired exposure time of the camera.

In general, changing the path length of the laser diode light can be done at any point prior to the light illuminating the sample. The path length change can be done even to the raw laser diode beam, which is optimal for small geometries and extremely high frequencies. Since the optical excursion of the illumination beam is only on the order of the wavelength of the laser diode light (typically between approximately 360 nm and 800 nm), the actual movement of the illumination beam is negligible in comparison to the area of the sample being illuminated by the beam.

In some embodiments, a modular design is used in which LEDs and/or laser diodes having certain wavelengths desirable for specific applications are selected and grouped into a package. That is, LEDs and/or laser diodes having emission wavelengths appropriate for use with live cell applications, protein applications, or standard epi-fluor applications are clustered into a set. For example, a live cell package could include LEDs and/or laser diodes emitting at wavelengths capable of exciting Cy5, CFP, GFP, YFP, and mFRP fluorochromes, as shown in Table 2.

TABLE 2

| | Target peak |
|---|---|
| Flurochrome | wavelength |
| Cy5 | 635 |
| CFP | 435 |
| GFP | 470-475 |
| YFP | 510 |
| mRFP | 590 |

A protein package could include LEDs and/or laser diodes capable of exiting UV, CFP, GFP, YFP, and mRFP fluorochromes, as shown in Table 3.

TABLE 3

| | Target peak |
|---|---|
| Flurochrome | wavelength |
| UV | 365 |
| CFP | 435 |
| GFP | 470-475 |
| YFP | 510 |
| mRFP | 590 |

An epi-fluor package could include LED and/or laser diodes emitting wavelengths capable of exciting Cy5, FITC, TRITC, and Texas red fluorochromes, as shown in Table 4.

TABLE 4

| | Target peak |
|---|---|
| Flurochrome | wavelength |
| Cy5 | 635 |
| DAPI | 365 |
| FITC | 470-475 |
| TRITC | 540 |
| Texas Red | 590 |

Other packages of LEDs and/or laser diodes are also possible. In general, a package includes between two and eight light sources selected to include wavelengths that are relevant to a particular application.

Interchangeable filter packages are also available. For example, a wide band filter (30 nm to 50 nm wide) eliminates the need for excitation filters. In another example, a narrow band filter would target multiband applications with multiband emission filters. Alternatively, the fluorescence microscopy system could include no filters, allowing users to utilize their own filter sets that already contain excitation and emission filters.

In one embodiment, a modular approach is used in which each LED or laser diode is set in a discrete module with its associated optics and cooling components. A modular approach allows LEDs or laser diodes to be replaced individually based on the current needs of a system. For example, if a laser diode of a particular wavelength was in use, and subsequently a high-powered LED at the same wavelength became available, the modular approach would allow replacement of the laser diode module with an LED module.

Other embodiments are in the claims. For example, although optical filter 11 was used to support phosphor layer 4, in other embodiments, other optical elements can be used to include a layer of a phosphor for emitting light of a different wavelength that overlaps with the peak excitation wavelength of a different fluorophore. Furthermore, additional optical components can be used, including mirrors, reflectors, collimators, beam splitters, beam combiners, dichroic mirrors, filters, polarizers, polarizing beam splitters, prisms, total internal reflection prisms, optical fibers, light guides, and beam homogenizers. The selection of appropriate optical components, as well as the arrangement of such components in a fluorescence microscopy system, is known to those skilled in the art. It is to be understood that the foregoing description is intended to illustrate and not to limit the scope of the invention, which is defined by the scope of the following claims.

What is claimed is:

1. An apparatus for providing light to molecules of a specimen in a fluorescence microscope, the molecules having a peak excitation wavelength, comprising:
a light-emitting diode (LED) emitting light at a first wavelength; and
an optical element including a phosphor, the phosphor capable of receiving the light at the first wavelength and emitting light at a preselected second wavelength different than the first wavelength, the second wavelength substantially similar to the peak excitation wavelength of the molecules.

2. The apparatus of claim 1, wherein the optical element is a dichroic short-pass thin film filter applied to a transparent substrate, the dichroic short-pass thin film filter configured to transmit the first wavelength and reflect the second wavelength.

3. The apparatus of claim 2, wherein the phosphor is applied as a thin film on an opposite side of the transparent substrate from the dichroic short-pass thin film filter, the transparent substrate oriented such that the dichroic short-pass thin film filter is on the side facing the LED.

4. The apparatus of claim 3, the dichroic short-pass thin film filter further configured to provide index matching between air and the transparent substrate.

5. The apparatus of claim 3, wherein the thickness of the thin film of the phosphor is sufficient to allow some of the light emitted by the LED to be transmitted through the thickness of the thin film.

6. The apparatus of claim 3, wherein the optical element further comprises a lens positioned to receive the light emitted by the phosphor.

7. The apparatus of claim 3, wherein the optical element further comprises a dichroic long-pass thin film filter positioned to receive the light emitted by the phosphor, the dichroic long-pass thin film filter capable of reflecting the first wavelength and transmitting the second wavelength.

8. The apparatus of claim 1, further comprising a liquid cooling system for cooling the optical element.

9. The apparatus of claim 1, wherein the first wavelength is 463 nm.

10. The apparatus of claim 9, wherein the second wavelength is 550 nm

11. The apparatus of claim 9, wherein the second wavelength is 537 nm.

12. The apparatus of claim 1, wherein the light emitted by the LED has a power of at least 6 Watts.

13. The apparatus of claim 12, wherein the light emitted by the LED has a power of between 6 and 8 Watts.

14. The apparatus of claim 12, wherein the phosphors are configured to convert at least 80% of the light emitted by the LED.

15. The apparatus of claim 14, wherein the phosphors are configured to convert between 80% and 90% of the light emitted by the LED.

16. An apparatus for providing light to molecules of a specimen in a fluorescence microscope, the molecules having at least one peak excitation wavelength, comprising:
a plurality of light-emitting diodes (LEDs), each LED emitting light at a different LED emission wavelength; and
a plurality of optical elements each including a phosphor, each optical element receiving the light emitted from one LED, each phosphor capable of receiving the light at the LED emission wavelength of the one LED and each phosphor emitting light at a different preselected phosphor emission wavelength, at least one of the phosphor emission wavelengths substantially similar to at least one of the peak excitation wavelengths of the molecules.

17. The apparatus of claim 16, further comprising a liquid cooling system for cooling the plurality of optical elements.

18. The apparatus of claim 16, further comprising a means for electronically switching each LED on and off.

19. The apparatus of claim 16, further comprising a plurality of dichroic mirrors, each dichroic mirror associated with one optical element, the plurality of dichroic mirrors configured to form the light emitted from each phosphor into a single beam.

20. An apparatus for providing light to molecules of a specimen in a fluorescence microscope, the molecules having a peak excitation wavelength, comprising:
a plurality of light-emitting diodes (LEDs) each emitting light at a first wavelength; and
an optical element including a phosphor, the phosphor capable of receiving the light at the first wavelength and emitting light at a preselected second wavelength different than the first wavelength, the second wavelength substantially similar to the peak excitation wavelength of the molecules.

21. An apparatus for providing light to molecules of a specimen in a fluorescence microscope, the molecules having a peak excitation wavelength, comprising:
a light-emitting diode (LED) emitting light at a first wavelength;
a first optical element including a first phosphor, the first phosphor capable of receiving the light at the first wavelength and capable of emitting light at a preselected second wavelength different than the first wavelength; and
a second optical element including a second phosphor, the second phosphor capable of receiving the light at the second wavelength and emitting light at a preselected third wavelength different than the first and second wavelengths, the third wavelength substantially similar to the peak excitation wavelength of the molecules.

22. An apparatus for providing light to molecules of a specimen in a fluorescence microscope, the molecules having a peak excitation wavelength, comprising:
a light-emitting diode emitting light at a first wavelength;
an optical element including a liquid containing quantum dots, the quantum dots capable of receiving the light at the first wavelength and capable of emitting light at a preselected second wavelength different than the first wavelength, the second wavelength substantially similar to the peak excitation wavelength of the molecules.

23. The apparatus of claim 22, wherein the optical element further includes a phosphor capable of receiving the light at the first wavelength and capable of emitting light at the second wavelength.

24. A system comprising:
a first light emitting diode or laser diode capable of emitting an output light having a first wavelength correlated with an excitation wavelength of a first fluorescent or phosphorescent molecule;
a first dichroic mirror disposed along an optical path from the first light emitting diode or laser diode to a microscope;
a second light emitting diode or laser diode capable of emitting an output light having a second wavelength correlated with an excitation wavelength of a second fluorescent or phosphorescent molecule, the first wavelength and the second wavelength being different; and
a second dichroic mirror disposed along an optical path from the second light emitting diode or laser diode to the microscope.

25. The system of claim 24, further comprising:
a first collimating device disposed along an optical path from the first light emitting diode or laser diode to the first dichroic mirror; and
a second collimating device disposed along an optical path from the second light emitting diode or laser diode to the second dichroic mirror.

26. The system of claim 24, further comprising:
a third light emitting diode or laser diode capable of emitting an output light having a third wavelength correlated with an excitation wavelength of a third fluorescent or phosphorescent molecule, the third wavelength being different from the first wavelength and the second wavelength;
a third dichroic mirror disposed along an optical path from the third light emitting diode or laser diode to the microscope;
a fourth light emitting diode or laser diode capable of emitting an output light having a fourth wavelength correlated with an excitation wavelength of a fourth fluorescent or phosphorescent molecule, the fourth wavelength being different from the first wavelength, the second wavelength, and the third wavelength; and
a fourth dichroic mirror disposed along an optical path from the fourth light emitting diode or laser diode to the microscope.

27. The system of claim 24, wherein:
the first light emitting diode or laser diode comprises an ultraviolet light emitting diode and the first wavelength is from about 200 nm to about 400 nm; and
the second light emitting diode or laser diode comprises a visible spectrum light emitting diode and the second wavelength is from about 400 nm to about 700 nm.

28. The system of claim 26, wherein:
the first light emitting diode or laser diode comprises an ultraviolet light emitting diode and the first wavelength is from about 200 nm to about 400 nm;
the second light emitting diode or laser diode comprises a blue light emitting diode and the second wavelength is from about 440 nm to about 480 nm;
the third light emitting diode or laser diode comprises a green light emitting diode and the third wavelength is from about 500 nm to about 570 nm; and
the fourth light emitting diode or laser diode comprises a red/orange light emitting diode and the fourth wavelength is from about 570 nm to about 700 nm.

29. The system of claim 26, wherein:
the first wavelength is from about 355 nm to about 375 nm;
the second light emitting diode or laser diode comprises a blue light emitting diode and the second wavelength is from about 460 nm to about 480 nm;
the third light emitting diode or laser diode comprises a green light emitting diode and the third wavelength is from about 515 nm to about 535 nm; and
the fourth light emitting diode or laser diode comprises a red/orange light emitting diode and the fourth wavelength is from about 580 nm to about 600 nm.

30. The system of claim 26, wherein:
the first wavelength is from about 360 nm to about 370 nm;
the second light emitting diode or laser diode comprises a blue light emitting diode and the second wavelength is from about 465 nm to about 475 nm;
the third light emitting diode or laser diode comprises a green light emitting diode and the third wavelength is from about 520 nm to about 530 nm; and
the fourth light emitting diode or laser diode comprises a red/orange light emitting diode and the fourth wavelength is from about 585 nm to about 595 nm.

31. The system of claim 26, wherein:
the first fluorescent or phosphorescent molecule comprises a fluorophore selected from the group consisting of DAPI and Hoechst;
the second fluorescent or phosphorescent molecule comprises a fluorophore selected from the group consisting of EGFP and FITC;
the third fluorescent or phosphorescent molecule comprises a fluorophore selected from the group consisting of TRITC and Cy3; and
the fourth fluorescent or phosphorescent molecule comprises a fluorophore selected from the group consisting of Texas Red and mCherry.

32. The system of claim 26, further comprising:
a third collimating device disposed along an optical path from the third light emitting diode or laser diode to the third dichroic mirror; and
a fourth collimating device disposed along an optical path from the fourth light emitting diode or laser diode to the fourth dichroic mirror.

33. The system of claim 24, further comprising a cooling system.

34. The system of claim 33, wherein the cooling system comprises a heat sink and a fan.

35. The system of claim 24, further comprising a control box operatively connected to the first light emitting diode or laser diode and the second light emitting diode or laser diode and configured to control the power applied to the first light emitting diode or laser diode and the second light emitting diode or laser diode.

36. The system of claim 35, wherein the control box further comprises a power switch and an LED enable switch.

37. A system comprising:
a first light emitting diode or laser diode capable of emitting an output light having a first wavelength correlated with an excitation wavelength of a first fluorescent or phosphorescent molecule, the first wavelength being from about 200 nm to about 400 nm;
a first dichroic mirror disposed along an optical path from the first light emitting diode or laser diode to a microscope;
a first collimating device disposed along an optical path from the first light emitting diode or laser diode to the first dichroic mirror;
a second light emitting diode or laser diode capable of emitting an output light having a second wavelength correlated with an excitation wavelength of a second fluorescent or phosphorescent molecule, the second wavelength being from about 440 nm to about 480 nm;
a second dichroic mirror disposed along an optical path from the second light emitting diode or laser diode to the microscope;
a second collimating device disposed along an optical path from the second light emitting diode or laser diode to the second dichroic mirror;
a third light emitting diode or laser diode capable of emitting an output light having a third wavelength correlated with an excitation wavelength of a third fluorescent or phosphorescent molecule, the third wavelength being from about 500 nm to about 570 nm;
a third dichroic mirror disposed along an optical path from the third light emitting diode or laser diode to the microscope;
a third collimating device disposed along an optical path from the third light emitting diode or laser diode to the third dichroic mirror;
a fourth light emitting diode or laser diode capable of emitting an output light having a fourth wavelength correlated with an excitation wavelength of a fourth fluorescent or phosphorescent molecule, the fourth wavelength being from about 570 nm to about 700 nm;
a fourth dichroic mirror disposed along an optical path from the fourth light emitting diode or laser diode to the microscope; and
a fourth collimating device disposed along an optical path from the fourth light emitting diode or laser diode to the fourth dichroic mirror.

38. The system of claim 37, wherein:
the first wavelength is from about 360 nm to about 370 nm;
the second light emitting diode or laser diode comprises a blue light emitting diode and the second wavelength is from about 465 nm to about 475 nm.
the third light emitting diode or laser diode comprises a green light emitting diode and the third wavelength is from about 520 nm to about 530 nm; and
the fourth light emitting diode or laser diode comprises a red/orange light emitting diode and the fourth wavelength is from about 585 nm to about 595 nm.

39. A system comprising:
a first light emitting diode capable of emitting light having a first wavelength correlated with an excitation wavelength of a first fluorescent or phosphorescent molecule;
a first laser diode capable of emitting light having a second wavelength correlated with an excitation wavelength of a second fluorescent or phosphorescent molecule, the second wavelength being different than the first wavelength,
one or more optical components configured to combine light emitted from the first light emitting diode and light emitted from the first laser diode to form an output light to a microscope; and
a control system configured to control an intensity of light of the first wavelength and an intensity of light of the second wavelength in the output light based on a desired characteristic of the output light and a respective output power emitted by the first light emitting diode and the first laser diode.
